(19) United States
(12) Patent Application Publication
(10) Pub. No.: US 2014/0003459 A1
(43) Pub. Date: Jan. 2, 2014

(54) PRE-IRRADIATION IN GAS DISCHARGE LASING DEVICES USING MULTIPLE PRE-IRRADIATION DISCHARGES PER ELECTRICAL FEED-THROUGH

(71) Applicant: IPG Microsystems LLC, Manchester, NH (US)

(72) Inventors: Jeffrey P. Sercel, Hollis, NH (US); Dana K. Sercel, Bedford, NH (US); Michael Von Dadelszen, Merrimack, NH (US); Daniel B. Masse, Windham, NH (US); Bruce R. Jenket, Center Harbor, NH (US)

(73) Assignee: IPG Microsystems LLC, Manchester, NH (US)

(21) Appl. No.: 13/721,821

(22) Filed: Dec. 20, 2012

Related U.S. Application Data
(60) Provisional application No. 61/577,955, filed on Dec. 20, 2011.

(51) Int. Cl. H01S 3/038

(52) U.S. Cl. CPC H01S 3/038
USPC 372/58

(57) ABSTRACT

A pre-irradiation system and method may be used in a gas discharge lasing device to provide multiple ultraviolet (UV) pre-irradiation discharges per electrical feed-through into a gas discharge chamber of the lasing device. One or more high-voltage electrical feed-throughs are electrically connected to one or more high-voltage electrodes that provide multiple discharge paths to a current return electrode to allow multiple pre-irradiation discharges per feed-through in response to high-voltage pulses applied via the feed-through(s). The discharge paths may include spark gap discharge paths and/or tracking discharge paths across an insulator. In some embodiments, multiple discharge paths are formed between respective tracking locators on a high voltage electrode and/or a current return electrode. In other embodiments, multiple discharge paths are formed between respective discharge locations on a high voltage electrode surrounded by an insulator, which spark or track to a current return electrode.

### RELATED APPLICATIONS

The present application claims the benefit of U.S. Provisional Patent Application Ser. No. 61/577,955 filed on Dec. 20, 2011, which is fully incorporated herein by reference.

### TECHNICAL FIELD

The present invention relates to gas lasing devices with transverse electric discharges, and more particularly, to the pre-irradiation of a gaseous medium in a gas lasing device using multiple pre-irradiation discharges per electrical feed-through.

### BACKGROUND INFORMATION

Gas lasing devices, such as excimer or exciplex lasers and amplifiers, use a gas or a gas mixture as a gain medium to amplify light and/or provide laser output. A transversely pumped, pulsed gas lasing device is typically pumped by transverse electric discharges in the presence of the gaseous gain medium. Such a lasing device may include a sealed discharge chamber containing the gaseous gain medium and main discharge electrodes. A main discharge region between the electrodes may be pre-irradiated to ionize the gas molecules before application of the main discharge voltage such that an avalanche glow discharge occurs at a consistent breakdown voltage and does not transition to an arc or contain an excessive quantity of streamers or branching discharges. A lack of sufficiently ionized gas in the discharge region, whether due to impurities or poor design of the laser vessel, may result in non-optimal gain or even loss of energy to the light passing through the medium.

One common pre-irradiation method for creating the requisite seed population of electrons and ions in commercial exciplex lasers uses deep ultraviolet (UV) light. The UV light may be generated by creating high current density arcs or surface discharges that may be continuous or in arrays and are offset to one or both sides of the main discharge electrodes. These high current density pre-irradiation discharges generate high energy UV photons that propagate into the gas that resides between the main discharge electrodes and photo-ionize a sufficient portion of laser gas molecules to allow for the generation of an avalanche glow discharge to pump the gas medium.

The discharge region occurring between the electrodes of a gas laser or amplifier should be uniformly pre-irradiated with UV in order to ensure that this discharge is uniform in intensity, as well as to confine the discharge to the space between the electrodes. The design of the pre-irradiation apparatus may directly impact repeatability in output efficiency. For many industrial applications, improved repeatability in output efficiency can result in higher product yield and less dependence on operator intervention for process adjustments and post-process inspection. Some applications are not even possible without a high degree of repeatability in output efficiency.

Existing methods to achieve the pre-irradiation of the discharge include the use of spark gaps and tracking (or sliding) methods. Spark gaps are generally formed by a number of pin electrodes that are discharged across free space to an anode pin or plate just before the main discharge occurs. The uniformity of the pre-irradiation may be dependent upon each electrode pin having the same breakdown voltage and carrying the same current. The pin break-down voltage is generally determined by the characteristics of the pin electrodes, such as shape and distance between the anode and the cathode and the characteristics of the laser gas, such as the partial pressures of each constituent and the total pressure/temperature of the gas.

Though the initial setup of such a spark gap system allows for an optimized and reasonably uniform breakdown voltage, and therefore a uniform discharge, this system degrades rapidly during the lifetime of the laser vessel. Sparking causes accelerated erosion of the cathode such that the distance between the cathode and the anode frequently changes non-uniformly between each of the pins, and the shape of the individual pin electrodes changes during the lifetime of the laser vessel. This results in altered and/or non-uniform breakdown voltages and non-uniform pre-irradiation of the discharge region. The time of the breakdown is dependent upon the magnitude of the breakdown voltage. A pin electrode requiring a larger breakdown voltage will discharge with a delay compared to pin electrodes with a lower breakdown voltage, leading to temporal non-uniformity. Moreover, erosion of the pin electrode material within the laser vessel results in debris, which may contribute to a change in the breakdown voltage or may become deposited on the laser window(s) or mirror(s) and have a direct negative impact upon laser efficiency, pulse stability and lifetime.

Surface tracking or sliding methods of pre-irradiation are an improvement to the spark-gap technique. In this method, an insulator is placed between the electrode pins such that the discharge tracks across a surface of the insulator, and an improved uniformity of the pre-irradiation is achieved throughout the lifetime of the laser vessel, with greatly reduced rates of degradation and contamination. The insulator defines a surface path for the electric current to travel between the electrode pins and often extends past the end of the electrode pin so that the tracking path continues to be defined as the pins erode and the gap increases. The tracking surface decreases the pre-irradiation system breakdown voltage and is a more efficient source of pre-irradiation ionization than the spark gap. Furthermore, the tracking discharge results in a reduced current density at the electrode surfaces, which may translate into less wear of the pins and longer component lifetime. The additional uniformity of the pre-irradiation results in greater discharge efficiency, more uniformity of the laser discharge and less arcing of the laser discharge, which directly results in longer gas lifetime than the spark-gap method. Tracking methods are further described in greater detail, for example, in U.S. Pat. Nos. 5,081,637 and 6,456,643, which are fully incorporated herein by reference.

Although the tracking/sliding methods provide many advantages over the spark gap approach, each tracking location requires a separate electrode and separate penetrations or feed-throughs into the laser discharge vessel, which can increase manufacturing cost and require higher manufacturing precision. Every penetration must be sealed with an o-ring, and each penetration is a potential source of contamination, increasing the probabilities of reduced efficiency of the laser and shorter component life. These existing pre-irradiation techniques therefore require a compromise between the quantity of electrodes and reduction of complexity and penetrations. Although reducing the number of high voltage penetrations or feed-throughs provides certain advantages, the reduction in electrodes also results in a loss of discharge uniformity of the pre-irradiation.

### BRIEF DESCRIPTION OF THE DRAWINGS

These and other features and advantages will be better understood by reading the following detailed description, taken together with the drawings wherein:

FIG. 1 is a schematic end view of a gas discharge lasing device with pre-irradiation using multiple pre-irradiation discharge paths per electrical feed-through, consistent with embodiments of the present disclosure.

FIG. 2A is a schematic side view of an exciplex laser with pre-irradiation using multiple pre-irradiation discharge paths per electrical feed-through, consistent with embodiments of the present disclosure.

FIG. 2B is a schematic side view of a gas amplifier with pre-irradiation using multiple pre-irradiation discharge paths per electrical feed-through, consistent with embodiments of the present disclosure.

FIGS. 3A and 3B are schematic views of pre-irradiation with separate electrical feed-throughs for each of the pre-irradiation discharges and illustrating the change in discharge uniformity longitudinally across a main discharge region when the number of feed-throughs and discharges is reduced.

FIG. 4 is a schematic view of pre-irradiation using multiple pre-irradiation discharges per electrical feed through, consistent with embodiments of the present disclosure, illustrating the discharge uniformity longitudinally across the main discharge region.

FIGS. 5A and 5B are schematic side and end views of a pre-irradiation subsystem with tracking locators on a high voltage electrode providing multiple tracking discharge paths per electrical feed-through, consistent with an embodiment of the present disclosure.

FIGS. 6A and 6B are schematic side and end views of a pre-irradiation subsystem with tracking locators on a current return electrode providing multiple tracking discharge paths per electrical feed-through, consistent with another embodiment of the present disclosure.

FIGS. 7A and 7B are schematic side and end views of an insulator configuration that may be used in a pre-irradiation subsystem to provide multiple tracking discharge paths per electrical feed-through in a pre-irradiation sub-system, consistent with yet another embodiment of the present disclosure.

FIGS. 8A-8C are schematic side and end views of other insulator configurations that may be used in a pre-irradiation subsystem providing multiple tracking discharge paths per electrical feed-through in a pre-irradiation sub-system, consistent with yet another embodiment of the present disclosure.

FIGS. 9A and 9B are schematic end and side views of a further insulator configuration on a single high-voltage electrode providing multiple tracking discharge paths per electrical feed-through in a pre-irradiation sub-system, consistent with a further embodiment of the present disclosure.

### DETAILED DESCRIPTION

A pre-irradiation system and method, consistent with embodiments of the present disclosure, may be used in a gas discharge lasing device to provide multiple ultraviolet (UV) pre-irradiation discharges per electrical feed-through into a gas discharge chamber of the lasing device. One or more high-voltage electrical feed-throughs are electrically connected to one or more high-voltage electrodes that provide multiple discharge paths to a current return electrode to allow multiple pre-irradiation discharges per feed-through in response to high-voltage pulses applied via the feed-through(s). The discharge paths may include spark gap discharge paths and/or tracking discharge paths across an insulator. In some embodiments, multiple discharge paths are formed between respective tracking locators on a high voltage electrode and/or a current return electrode. In other embodiments, multiple discharge paths are formed between respective discharge locations on a high voltage electrode surrounded by an insulator, which spark or track to a current return electrode.

The gas discharge lasing device may include an exciplex gas laser or amplifier including main electrodes contained within a vessel or gas discharge chamber containing a mixture of rare-halide or halide gases, wherein the gaseous gain medium between the electrodes is pumped by an electrical discharge. Rare-halide gas may include, for example, ArF, KrF, XeCl, and XF and halide may include, for example, F₂ or HCl. A buffer gas that constitutes the majority of the gas constituents dilutes these gases. The buffer gas may include Ne or He.

As used herein, “pre-irradiation” refers to the distribution of ionizing ultraviolet radiation within the main discharge region of the laser or amplifier between the main discharge electrodes before the main discharge. As used herein, “pre-irradiation discharges” refers to the electrical discharge that occurs before the main discharge across the main discharge electrodes to provide the UV pre-irradiation and “discharge path” refers to a discrete path between electrodes or locations on electrodes along which current flows during a pre-irradiation discharge. As used herein, “electrical feed-through” refers to a conductive element that penetrates or passes into a gas discharge chamber of the gas laser or amplifier to a pre-irradiation sub-system located in the discharge chamber, for example, to supply a high-voltage pulse and “multiple pre-irradiation discharges per electrical feed-through” refers to multiple pre-irradiation discharges resulting from high-voltage on the electrical feed-through and occurring at substantially the same time.

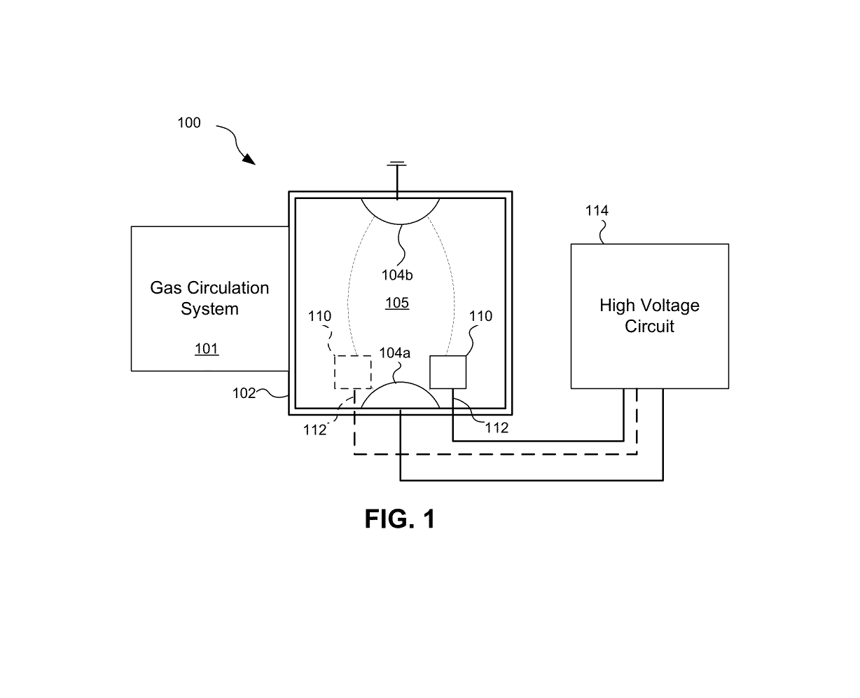

Referring to FIG. 1, a pre-irradiation sub-system 110 providing multiple pre-irradiation discharges per feed-through, consistent with embodiments of the present disclosure, may be used with a gas discharge lasing device 100, such as a gas laser or a gas optical amplifier. The gas discharge lasing device 100 generally includes a sealed gas discharge chamber 102 configured to receive one or more gases, main discharge electrodes 104a, 104b located in the discharge chamber 102 and configured to discharge in a gas discharge region 105, and a high-voltage circuit 114 electrically connected to at least one of the electrodes 104a and configured to electrically pump the gaseous gain medium by transverse electric discharges. Gas breakdown occurs transversely in the discharge region 105 between the electrodes 104a, 104b when enough energy is inputted and the discharge medium is at an optimal state. The discharge is the means by which the gaseous gain medium is pumped into the lasing upper state for net gain generation. The gas lasing device 100 may also include a gas circulation system 101 for circulating the gases through the gas discharge chamber.

The pre-irradiation sub-system 110 is also electrically connected to the high-voltage circuit 114 using one or more high-voltage electrical feed-throughs 112 that penetrate and pass through the discharge chamber 102 such that the high-voltage circuit 114 powers the pre-irradiation subsystem 110 to provide the pre-irradiation discharges. Each of the electrical feed-throughs 112 may provide high voltage pulses to generate multiple pre-irradiation discharges per feed-through along a side of the main electrode 104a, as described in greater detail below. Another pre-irradiation sub-system 110 may be located on the other side of the main electrode 104a, as shown. Pre-irradiation sub-systems 110 may also be located proximate the other electrode 104b on one or both sides (not shown). The high-voltage circuit 114 may include a high-voltage supply and a pulse forming network capable of forming high-voltage pulses that may be applied to the main electrode 104a and pre-irradiation sub-system 110 at a defined intensity, duration and repetition rate depending upon the application.

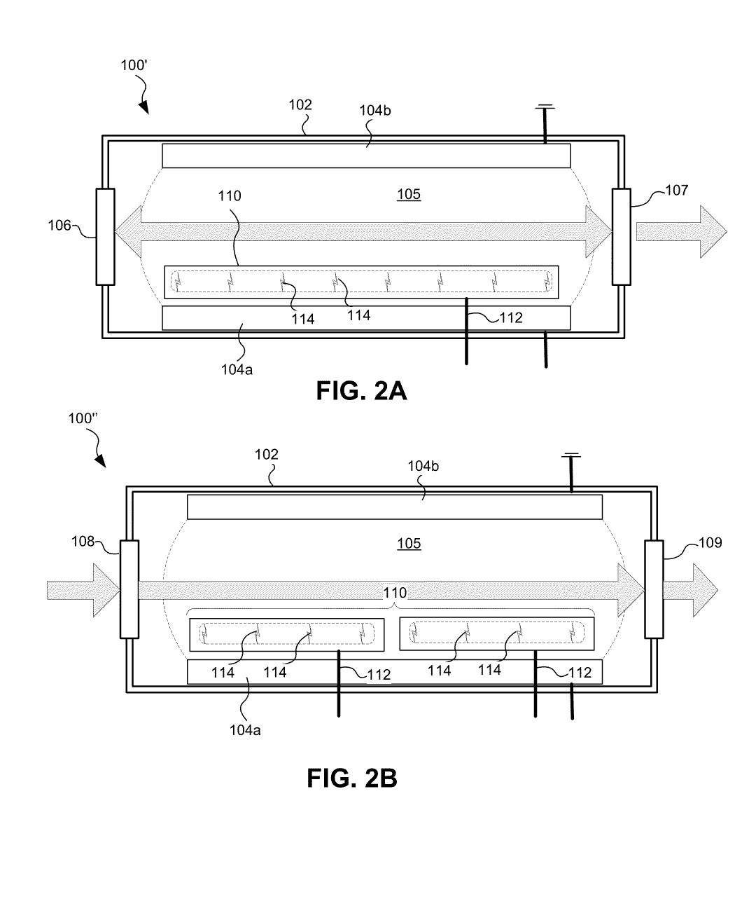

As shown in FIG. 2A, a gas discharge laser 100′ includes resonator optics, such as a minor or reflector 106 and a partial reflector 107, forming a resonator cavity in the gas discharge region 105. In gas lasers, the main discharge is typically of sufficient duration for the intracavity photons to increase in intensity while circulating through the length of the cavity multiple times and to be emitted out of the front of the cavity. Exciplex gas lasers may use rare and halide gas mixtures or halogen gas in conjunction with a buffer gas to emit light in the ultra-violet region.

As shown in FIG. 2B, a gas amplifier 100″ includes front and rear windows or transparent regions 108, 109 and allows light to pass through the gas discharge region 105 for amplification. In the optical amplifier, the incoming photons are amplified while transiting through the excited medium, either in a single pass or in multiple passes.

As shown in both FIGS. 2A and 2B, the main discharge electrodes 104a, 104b extend longitudinally along the gas discharge chamber 102 and are separated by the gas discharge region 105. The pre-irradiation sub-system 110 generally extends along the length of the main discharge electrode 104a and the gas discharge region 105, although the pre-irradiation sub-system 110 may extend along only a portion of the gas discharge region 105. The pre-irradiation subsystem 110 may include one or more electrical feed-throughs 112 and a plurality of discharge paths 114 electrically connected to each of the electrical feed-throughs 112 and spaced longitudinally across the discharge region 105 and proximate the main discharge electrode 104a. The discharge paths 114 may include spark gap discharge paths and/or tracking discharge paths.

In the illustrated embodiment in FIG. 2A, one electrical feed-through 112 is electrically connected to a group of discharge paths 114 extending along the length of the main electrode 104a. In the illustrated embodiment in FIG. 2B, two electrical feed-throughs 112 are electrically connected to two separate groups of discharge paths 114. Additional feed-throughs and corresponding groups of discharge paths are also possible. The groups of discharge paths electrically connected to a single electrical feed-through may also include fewer or greater numbers of discharge paths.

When pre-irradiation sub-systems 110 are provided on each side of the electrode 104a (as shown in FIG. 1), the discharge paths 114 provided by each of the sub-systems 110 may be positioned symmetrically opposed to one another across the width of the discharge region 105. Alternatively, the discharge paths 114 may be positioned such that the locations on opposite sides across the discharge region 105 are not directly opposed. The number and geometry of the discharge paths 114 may also be varied along the length and across the width of the discharge region 105.

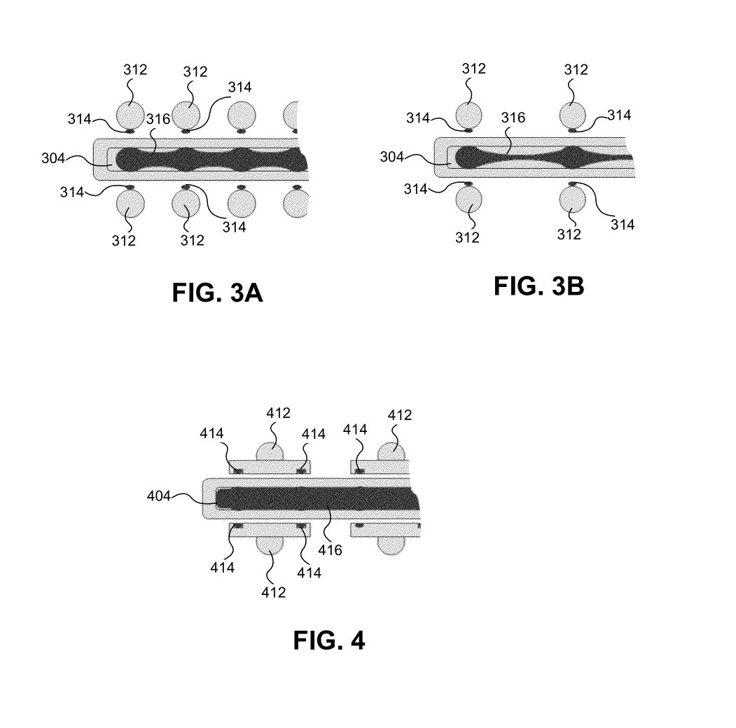

Multiple discharge paths per high voltage feed-through result in fewer penetrations per laser or amplifier while maintaining a uniformity of pre-irradiation consistent or better than other pre-irradiation techniques. A reduction in penetrations and power feed-through sites reduces manufacturing cost, part count and complexity. Reducing the number of seals required for the feed-throughs and the potential for contamination also improves laser performance, thus providing a commercial maintenance, cost and performance advantage over the existing techniques. As shown in FIG. 3A, for example, multiple electrodes and pre-irradiation discharges 314 may be used to achieve a substantially uniform pre-irradiation 316 across a discharge region along a main electrode 304, but high-voltage electrical feed-throughs 312 are required for each of the electrodes and pre-irradiation discharges 314. Although reducing the number of high-voltage electrical feed-throughs 312, as shown in FIG. 3B, provides certain advantages, the reduction in electrodes and pre-irradiation discharges 314 also results in a loss of discharge uniformity of the pre-irradiation 316. In contrast, a pre-irradiation sub-system, consistent with embodiments of the present disclosure, provides multiple pre-irradiation discharges 414 per electrical feed-through 412, as shown in FIG. 4, which reduces the number of penetrations while maintaining a substantially uniform pre-irradiation 416 across a discharge region along a main electrode 404. As discussed in greater detail below, the multiple pre-irradiation discharges 414 may be provided using a distributed high voltage tracker with multiple tracking locations (i.e., across insulators) or using multiple spark gaps per electrical feed-through (i.e., without insulators).

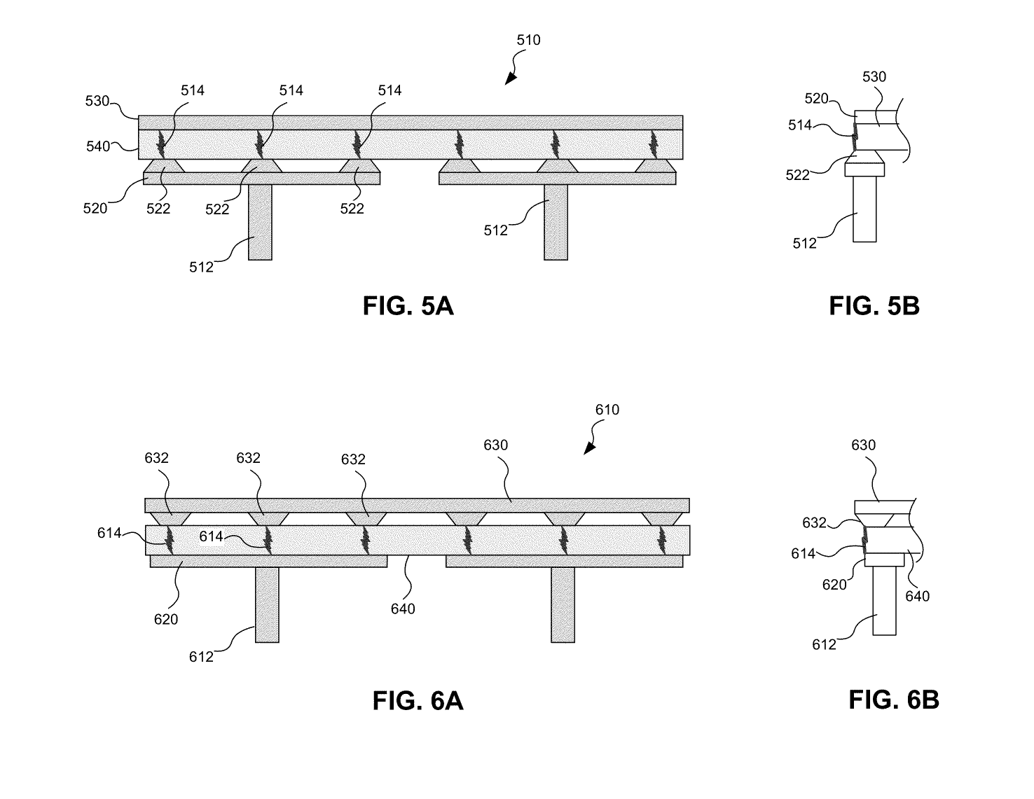

One embodiment of a pre-irradiation system 510, shown in FIGS. 5A and 5B, includes high-voltage electrical feed-throughs 512 electrically connected to high voltage electrodes 520 with multiple tracking locators 522 protruding from the high voltage electrodes 520 and tracking to a single current return electrode 530. Each of the high voltage tracking locators 522 locates a discharge path 514 across an insulator 540 to the current return electrode 530. The high voltage electrodes 520 are spaced from the current return electrode 530 such that the tracking locators 522 discharge to the current return electrode 530 across the discharge paths 514.

Another embodiment of a pre-irradiation sub-system 610, shown in FIGS. 6A and 6B, includes high-voltage electrical feed-throughs 612 electrically connected to high voltage electrodes 620, which spark or track to multiple tracking locators 632 protruding from a current return electrode 630. Each of the current return tracking locators 632 locates a discharge path 614 across an insulator 640 from the high voltage electrodes 620. The high voltage electrodes 620 are spaced from the current return electrode 630 such that the high voltage electrodes 620 discharge to the tracking locators 632 on the current return electrode 530 across the discharge paths 614.

The high voltage feed-throughs 512, 612 may be electrically connected to a high voltage circuit for receiving high voltage pulses and the current return electrodes 530, 630 may be electrically connected to a current return circuit. The high voltage electrodes 520, 620 may be cathodes and the current return electrodes 530, 630 may be anodes such that pre-irradiation discharges track from the cathodes or cathode locations to the anodes or anode locations. The tracking locators 522, 632 may be electrically conductive pads that protrude from the electrodes 520, 630 at a sufficient distance such that pre-irradiation discharges occur from or to the tracking locators 522, 632 rather than other locations on the electrodes 520, 630. Thus, the tracking locators 522, 632 effectively form multiple separate electrodes that contact the insulator 540, 640. The insulator 540, 640 may be made of a dielectric material having a relatively large dielectric constant and may have various configurations, as described in greater detail below.

In both of the embodiments described above, the tracking locators distribute the high voltage pulses, and resulting pre-irradiation discharges, across the high voltage electrodes and current return electrodes allowing multiple pre-irradiation discharges per electrical feed-through. The distance between the high voltage electrodes and the current return electrodes at each electrode location may be configured (e.g., by adjusting the thickness of the insulator and/or the height of the locator pads) to make the break-down voltage, current, and time of the main electrical discharge more uniform and consistent from pulse to pulse.

Insulators or electrode geometry may also be configured such that the breakdown at each pre-irradiation discharge occurs at a uniform time, voltage, and current. Insulator geometry may be used to direct the location of the breakdown to be more uniform in spatial location and to be most advantageous to the pre-irradiation process. The tracking surface may be shaped, for example, as a planar, convex or concave surface to maximize or increase the exposure of the main discharge region to the pre-irradiation.

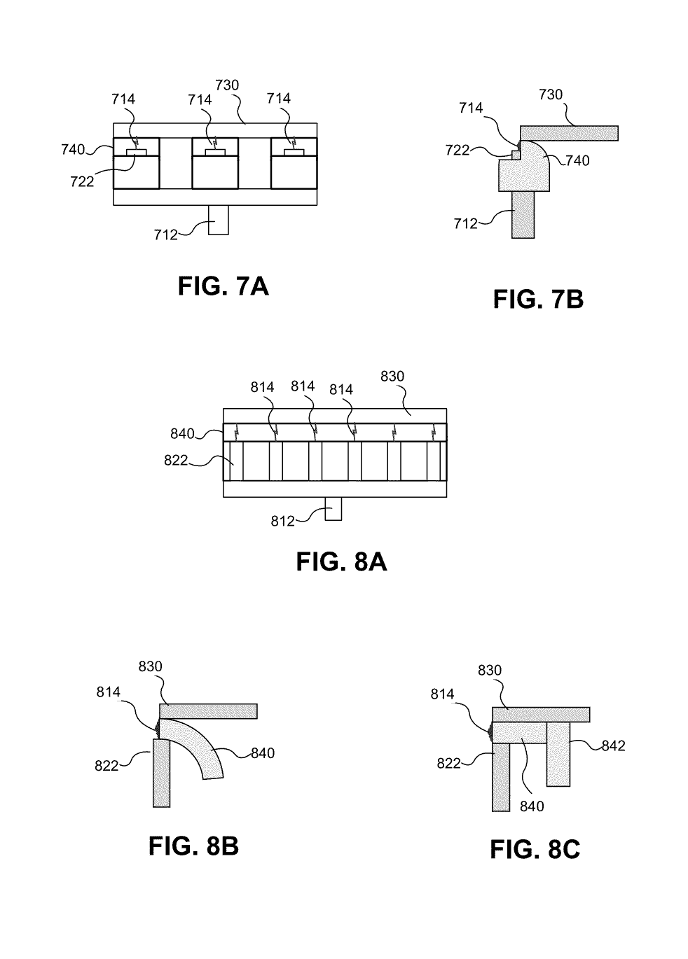

In one embodiment, shown in FIGS. 7A and 7B, a plurality of high voltage electrodes 722 are electrically connected to a single electrical feed-through 712 and insulators 740 of dielectric material surround each of the electrodes 722. The high voltage electrodes 722 are spaced from a current return electrode 730 such that the high voltage electrodes discharge to the current return electrode 730 across the respective discharge paths 714. The insulators 740 form exposed discharge locations at the ends of the high voltage electrodes 722, which restricts the discharge paths 714 to one optimal area of the high voltage electrodes 722 and prevents arcing erroneously to other electrodes or current return locations.

In other embodiments, shown in FIGS. 8A-8C, a plurality of high voltage electrodes 822 are electrically connected to a single electrical feed-through 812 and an insulator 840 of dielectric material is located between the high voltage electrodes 822 and a current return electrode 830. The high voltage electrodes 822 are spaced from the current return electrode 830 such that the high voltage electrodes discharge to the current return electrode 830 across the respective discharge paths 814. The insulator 840 provides a tracking surface and restricts the discharge paths 814 to an optimum surface of the high-voltage electrodes 822. The insulator configurations shown in FIGS. 8A-8C may be used in the embodiments of the pre-irradiation sub-system 510, 610 shown in FIGS. 5A-6B.

As shown in FIG. 8B, a single insulator 840 may be curved toward the high voltage electrodes 822. The curved geometry of the insulator 840 allows for a compact footprint of the assembly and maximizes the tracking surface distance to insulator volume ratio. As shown in FIG. 8C, two or more insulators 840 may be used with the first insulator 840 positioned between the electrodes 822, 830 and extending along the current return electrode 830 and the second insulator 842 extending in a direction of the high-voltage electrodes 822. A sufficiently small gap between the insulators 840, 842 will ensure the discharge path 814 is restricted to an optimum surface of the electrode 822. This configuration of multiple insulators 840, 842 allows for variations in electrode distance and geometry to be designed for multiple laser/amplifier configurations while retaining an equivalent implementation across all configurations, which may be more cost effective than having different shaped insulators for different laser/amplifier configurations. The geometry can also be made to be compact such that the pre-irradiation footprint is small.

Another embodiment of a pre-irradiation sub-system may include a surface or volume with a defined dielectric constant interposed between the conductive electrode and the tracking surface to provide an enhanced capacitive component to the pre-irradiation circuit to improve the uniformity across all the pre-irradiation locations. The dielectric surface or volume may be the same or different for each electrode, as determined to be necessary for uniform pre-irradiation of the discharge volume.

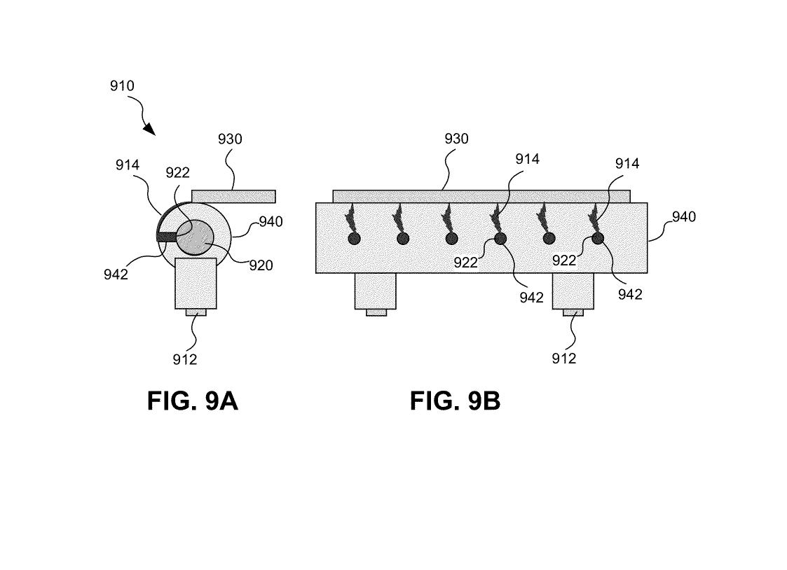

A further embodiment of a pre-irradiation sub-system 910, as shown in FIGS. 9A and 9B, includes a single high voltage electrode 920 electrically connected to each of the high voltage feed-throughs 912 with an insulator 940 surrounding the high voltage electrode 920. The insulator 940 defines a plurality of exposed discharge locations 922 on the high voltage electrode 920, which spark or track along multiple discharge paths 914 to a single current return electrode 930. In one example, the single high voltage electrode 920 is rod-shaped and the insulator 940 is tube-shaped and surrounds the rod-shaped electrode 920. The tube-shaped insulator 940 includes a series of apertures 942 that expose the exposed discharge locations 922 on the high voltage electrode 920 within the insulator 940. Thus, the pre-irradiation discharges exit the insulator 940 and track across the insulator 940 to the current return electrode 930 such that the discharge paths 914 are defined and tracking is prevented at non-optimal locations.

The arcuate surface of the tube-shaped insulator 940 may help direct the pre-irradiation toward the gas discharge regions in a gas lasing device. The rod-shaped high voltage electrode 920 contained along the centerline of the tube-shaped insulator 940 may also be rotated and/or repositioned along its length in order to present new surfaces to the tracking apertures in the event that the electrode surface has been degraded. Although the tube-shaped insulator 940 and the rod-shaped electrode 920 are shown as cylindrical, other shapes and configurations are possible. The illustrated embodiment shows two electrical feed-throughs 912, which are connected to two respective high voltage electrodes 920; however, other numbers of feed-throughs and electrodes are possible.

Pre-irradiation sub-systems, consistent with embodiments described herein, may also provide the opportunity to balance the spark or tracking discharges across the multiple discharge paths to ensure optimum uniformity of the pre-irradiation. Each discharge circuit formed by a high voltage electrode, discharge path, and current return electrode has an inherent resistance, capacitance and inductance that can be used singly or in combination to ensure uniform pre-irradiation. In the pre-irradiation sub-system 910, for example, the tube-shaped insulator 940 provides capacitive coupling between the rod-shaped high voltage electrode 920 and the current return electrode 930. The array of apertures 942 in the tub-shaped insulator 940 provides both resistive and inductive balancing. Quenching of the plasma at the walls of the apertures 942 adds series resistance to each of the discharge circuits and the length to diameter ratio of the apertures 942 adds series inductance to each of the discharge circuits. The aperture spacings and the optimum dielectric wall thickness, aperture dimensions and aperture geometry may vary for different implementations.

The apertures 942 may be configured in geometry so as to change the equivalent series inductance and impedance to maintain a consistent breakdown voltage, current, and time for the pre-irradiation discharges, thereby providing uniformity of pre-irradiation. For example, the apertures may be tapered either inwardly or outwardly or have a varying taper. The apertures may also have circular, rectangular, oval, or other geometrical cross sections.

Accordingly, pre-irradiation systems and methods providing multiple pre-irradiation discharges per electrical feed-through, consistent with embodiments described herein, are capable of providing uniform pre-irradiation in a gas lasing device while reducing or minimizing the number of penetrations into a gas discharge chamber. Various geometries and configurations of electrodes and insulators may be used to control the discharge paths, which enables multiple pre-irradiation discharges per feed-through and uniform pre-irradiation.

Consistent with an embodiment, a gas lasing device includes a gas discharge chamber configured to receive a gas and a plurality of main discharge electrodes located in and extending longitudinally along the gas discharge chamber and separated by a gas discharge region. The gas lasing device also includes a pre-irradiation sub-system configured to provide a plurality of pre-irradiation discharges per electrical feed-through. The pre-irradiation sub-system includes at least one electrical feed-through and a plurality of discharge paths electrically connected to the electrical feed-through such that pre-irradiation discharges occur across the discharge paths, respectively, in response to high voltage pulses delivered via the electrical feed-through. The plurality of discharge paths are spaced longitudinally across the discharge region and proximate at least one of the main discharge electrodes. The gas lasing device also includes a high-voltage circuit electrically connected to the main discharge electrodes and electrically connected to the pre-irradiation sub-system via the at least one electrical feed-through. The high-voltage circuit is configured to supply the high-voltage pulses to the pre-irradiation sub-system and to the main discharge electrodes. The pre-irradiation sub-system is configured to produce pre-irradiation discharges across the discharge paths in response to each high-voltage current pulse to ionize the lasing gas. The main discharge electrodes are configured to produce, subsequent to the pre-irradiation discharges, a main discharge in the gas discharge region between the main discharge electrodes in response to each high-voltage current pulse to form a gaseous gain medium.

Consistent with another embodiment, a pre-irradiation system provides a plurality of pre-irradiation discharges per electrical feed-through in a gas discharge lasing device. The pre-irradiation system includes at least one electrical feed-through, at least one high voltage electrode electrically connected to the electrical feed-through, and a current return electrode spaced from the high voltage electrode and forming a plurality of discharge paths such that pre-irradiation discharges occur across the discharge paths, respectively, in response to high voltage pulses delivered via the electrical feed-through.

Consistent with a further embodiment, a method is provided for pre-irradiation of a gaseous gain medium in a gas discharge chamber of a gas lasing device. The method includes: providing a gaseous gain medium in the gas discharge chamber; and delivering at least one high voltage pulse on at least one electrical feed-through into the gas discharge chamber to cause multiple pre-irradiation discharges, in response to the high voltage pulse, on multiple discharge paths electrically connected to the one electrical feed-through, thereby pre-irradiating the gain medium in the discharge chamber.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A gas lasing device comprising:
a gas discharge chamber configured to receive a gas;
a plurality of main discharge electrodes located in and extending longitudinally along the gas discharge chamber and separated by a gas discharge region;
a pre-irradiation sub-system configured to provide a plurality of pre-irradiation discharges per electrical feed-through, the pre-irradiation sub-system including at least one electrical feed-through and a plurality of discharge paths electrically connected to the electrical feed-through such that pre-irradiation discharges occur across the discharge paths, respectively, in response to high voltage pulses delivered via the electrical feed-through, the plurality of discharge paths being spaced longitudinally across the discharge region and proximate at least one of the main discharge electrodes; and
a high-voltage circuit electrically connected to the main discharge electrodes and electrically connected to the pre-irradiation sub-system via the at least one electrical feed-through, the high-voltage circuit being configured to supply the high-voltage pulses to the pre-irradiation sub-system and to the main discharge electrodes, wherein the pre-irradiation sub-system is configured to produce pre-irradiation discharges across the discharge paths in response to each high-voltage current pulse to ionize the lasing gas and wherein the main discharge electrodes are configured to produce, subsequent to the pre-irradiation discharges, a main discharge in the gas discharge region between the main discharge electrodes in response to each high-voltage current pulse to form a gaseous gain medium.

2. The gas lasing device of claim 1 wherein the plurality of discharge paths include a plurality of spark discharge paths.

3. The gas lasing device of claim 1 wherein the plurality of discharge paths include a plurality of tracking discharge paths.

4. The gas lasing device of claim 1 wherein the pre-irradiation sub-system comprises:
a plurality of high voltage electrodes electrically connected to the electrical feed-through; and
a current return electrode spaced from the high voltage electrodes such that the high voltage electrodes discharge to the current return electrode across the plurality of discharge paths.

5. The gas lasing device of claim 4 wherein the pre-irradiation sub-system further comprises at least one insulator positioned between the high voltage electrodes and the current return electrode such that the discharge paths are formed from ends of the high voltage electrodes.

6. The gas lasing device of claim 5 wherein the insulator is curved toward the high voltage electrodes to prevent discharges from other locations on the high voltage electrodes.

7. The gas lasing device of claim 1 wherein the pre-irradiation sub-system comprises:
at least one high voltage electrode electrically connected to the at least one electrical feed-through, the high voltage electrode including a plurality of tracking locators protruding from the high voltage electrode; and
a current return electrode spaced from the high voltage electrode such that the plurality of tracking locators discharge to the current return electrode across the plurality of discharge paths.

8. The gas lasing device of claim 1 wherein pre-irradiation sub-system comprises:
at least one high voltage electrode electrically connected to the at least one electrical feed-through; and
a current return electrode including a plurality of tracking locators protruding from the current return electrode, wherein the current return electrode is spaced from the high voltage electrode such that the high voltage electrode discharges to the plurality of tracking locators on the current return electrode along the plurality of discharge paths.

9. The gas lasing device of claim 1 wherein the pre-irradiation sub-system comprises:
at least one high voltage electrode electrically connected to the at least one electrical feed-through;
at least one insulator around at least a portion of the high voltage electrode forming a plurality of exposed discharge locations on the high voltage electrode; and
a current return electrode spaced from the high voltage electrode such that the exposed discharge locations on the high voltage electrode discharges to the current return electrode along the plurality of discharge paths.

10. The gas lasing device of claim 9 wherein the high voltage electrode is rod shaped, wherein the insulator is tube-shaped and surrounds the rod-shaped high voltage electrode, and wherein the tube-shaped insulator defines a plurality of tracking apertures exposing the exposed discharge locations and allowing the pre-irradiation discharges to exit the insulator and track across the insulator to the current return electrode.

11. The gas lasing device of claim 10 wherein the insulator provides an arcuate outer tracking surface.

12. The gas lasing device of claim 9 wherein the at least one high voltage electrode includes a plurality of high voltage electrodes electrically connected to the high voltage feed-through, and wherein the at least one insulator includes insulators surrounding the high voltage electrodes, respectively, forming the plurality of exposed discharge locations at ends of the high voltage electrodes, respectively.

13. The gas lasing device of claim 1 wherein the pre-irradiation sub-system includes a plurality of electrical feed-throughs, wherein each of the electrical feed-throughs is electrically connected to a group of discharge paths.

14. A pre-irradiation system for providing a plurality of pre-irradiation discharges per electrical feed-through in a gas discharge lasing device, the pre-irradiation system comprising:
at least one electrical feed-through;
at least one high voltage electrode electrically connected to the electrical feed-through; and
a current return electrode spaced from the high voltage electrode and forming a plurality of discharge paths such that pre-irradiation discharges occur across the discharge paths, respectively, in response to high voltage pulses delivered via the electrical feed-through.

15. The pre-irradiation system of claim 14 further comprising a plurality of tracking locators extending from at least one of the high voltage electrode and the current return electrode, wherein the discharge paths extend from or to the tracking locators.

16. The pre-irradiation system of claim 14 further comprising at least one insulator positioned between the high voltage electrode and the current return electrode such that the discharge paths are formed across the insulator.

17. The pre-irradiation system of claim 14 further comprising at least one insulator around at least a portion of the high voltage electrode forming a plurality of exposed discharge locations on the high voltage electrode, wherein the discharge paths extend from the exposed discharge locations on the high voltage electrode to the current return electrode.

18. A method of pre-irradiation of a gaseous gain medium in a gas discharge chamber of a gas lasing device, the method comprising:
providing a gaseous gain medium in the gas discharge chamber; and
delivering at least one high voltage pulse on at least one electrical feed-through into the gas discharge chamber to cause multiple pre-irradiation discharges, in response to the high voltage pulse, on multiple discharge paths electrically connected to the one electrical feed-through, thereby pre-irradiating the gain medium in the discharge chamber.

19. The method of claim 18 wherein delivering at least one high voltage pulse includes delivering a series of high voltage pulses to electrically pump the gaseous gain medium at a defined intensity, duration, and repetition rate.

20. The method of claim 18 wherein the pre-irradiation discharges track along an insulator between at least one high voltage electrode and at least one current return electrode.
